(19) United States
(12) Patent Application Publication
(10) Pub. No.: US 2022/0335654 A1
(43) Pub. Date: Oct. 20, 2022

(54) METHOD AND APPARATUS FOR GENERATING POINT CLOUD ENCODER, METHOD AND APPARATUS FOR GENERATING POINT CLOUD DATA, ELECTRONIC DEVICE AND COMPUTER STORAGE MEDIUM

(71) Applicant: SENSETIME INTERNATIONAL PET LTD., Singapore (SG)

(72) Inventors: Zhongang CAI, Singapore (SG); Xinyi CHEN, Singapore (SG); Junzhe ZHANG, Singapore (SG); Halyu ZHAO, Singapore (SG); Sbuai YI, Singapore (SG)

(21) Appl. No.: 17/363,458

(22) Filed: Jun. 30, 2021

Related U.S. Application Data
(63) Continuation of application No. PCT/IB2021/054758, filed on May 31, 2021.

(30) Foreign Application Priority Data
Apr. 15, 2021 (SG) 10202103893T

(51) Int. Cl. G06T 9/00; G06T 3/00; G06K 9/62

(52) U.S. Cl. CPC G06T 9/001; G06T 3/00; G06K 9/6232; G06K 9/6288; G06K 9/6298

(57) ABSTRACT

Method and apparatus for generating point cloud encoder, method and apparatus for generating point cloud data, electronic device and computer storage medium are provided. The method for generating point cloud encoder includes: first point cloud data and second point cloud data of an object are acquired; a first probability distribution of a global feature of the first point cloud data is determined based on a first encoder; a second probability distribution of a global feature of the second point cloud data is determined based on a second encoder; a weight of the first encoder is regulated based on a first difference between the first probability distribution and the second probability distribution to obtain a target weight of the first encoder; and a point cloud encoder is generated according to the first encoder and the target weight.

### CROSS-REFERENCE TO RELATED APPLICATIONS

This is a continuation application of International Patent Application No. PCT/IB2021/054758, filed on 31 May 2021, which claims priority to Singapore Patent Application No. 10202103893T, filed to the Singapore Patent Office on 15 Apr. 2021 and entitled “METHOD AND APPARATUS FOR GENERATING POINT CLOUD ENCODER, METHOD AND APPARATUS FOR GENERATING POINT CLOUD DATA, ELECTRONIC DEVICE AND COMPUTER STORAGE MEDIUM”. The contents of International Patent Application No. PCT/IB2021/054758 and Singapore Patent Application No. 10202103893T are incorporated herein by reference in their entireties.

### BACKGROUND

A laser radar or a depth camera may be deployed in various types of scenarios, such as a monitoring scenario and a shooting scenario, to collect point cloud data. Point cloud data, as supplementary data of an image, may be adopted to acquire more real scenario information.

However, point cloud data collected through a laser radar or a depth camera is usually sparse and incomplete. For example, under the condition that an object is occluded by a certain occlusion, point cloud data of an occluded region of the object may not be collected. For determining the point cloud data of the occluded region of the object, the collected point cloud is required to be completed to obtain the point cloud data of the occluded region of the object.

Therefore, how to generate a point cloud encoder to complete collected point cloud data of a certain object is a problem urgent to be solved by technicians.

### SUMMARY

Embodiments of the disclosure relate to, but not limited to, machine learning, and particularly relate to a method and an apparatus for generating point cloud encoder, a method and an apparatus for generating point cloud data, an electronic device and a computer storage medium.

The embodiments of the disclosure provide point cloud encoder and point cloud data generation methods and apparatuses, a device and a medium.

A first aspect provides a method for generating point cloud encoder, which may include the following operations. First point cloud data and second point cloud data of an object are acquired. Completeness of the second point cloud data is higher than completeness of the first point cloud data. A first probability distribution of a global feature of the first point cloud data is determined based on a first encoder. A second probability distribution of a global feature of the second point cloud data is determined based on a second encoder. The first encoder and the second encoder share a weight. A weight of the first encoder is regulated based on a first difference between the first probability distribution and the second probability distribution to obtain a target weight of the first encoder. A point cloud encoder is generated according to the first encoder and the target weight.

A second aspect provides a method for generating point cloud data, which may include the following operations. To-be-processed point cloud data obtained by shooting an object is acquired. A target probability distribution of a global feature of the to-be-processed point cloud data is determined based on the to-be-processed point cloud data and a trained first encoder. Point cloud completion is performed on the to-be-processed point cloud data based on the target probability distribution to generate target point cloud data. Completeness of the target point cloud data is higher than completeness of the to-be-processed point cloud data. A target weight of the first encoder may be obtained by regulating a weight of the first encoder at least based on a first difference between a first probability distribution, determined by the first encoder, of a global feature of first point cloud data and a second probability distribution, determined by a second encoder, of a global feature of second point cloud data. Completeness of the second point cloud data is higher than completeness of the first point cloud data.

A third aspect provides a point cloud encoder generation apparatus, which may include the following units. An acquisition unit, configured to acquire first point cloud data and second point cloud data of an object. Completeness of the second point cloud data is higher than completeness of the first point cloud data. A first determination unit is configured to determine a first probability distribution of a global feature of the first point cloud data based on a first encoder. A second determination unit is configured to determine a second probability distribution of a global feature of the second point cloud data based on a second encoder. The first encoder and the second encoder share a weight. A regulation unit is configured to regulate a weight of the first encoder based on a first difference between the first probability distribution and the second probability distribution to obtain a target weight of the first encoder. A generation unit is configured to generate a point cloud encoder according to the first encoder and the target weight.

A fourth aspect provides a point cloud data generation apparatus, which may include the following units. An acquisition unit is configured to acquire to-be-processed point cloud data obtained by shooting an object. A first determination unit is configured to determine a target probability distribution of a global feature of the to-be-processed point cloud data based on the to-be-processed point cloud data and a trained first encoder. A second determination unit is configured to perform point cloud completion on the to-be-processed point cloud data based on the target probability distribution to generate target point cloud data. Completeness of the target point cloud data is higher than completeness of the to-be-processed point cloud data. A target weight of the first encoder may be obtained by regulating a weight of the first encoder at least based on a first difference between a first probability distribution, determined by the first encoder, of a global feature of first point cloud data and a second probability distribution, determined by a second encoder, of a global feature of second point cloud data. Completeness of the second point cloud data is higher than completeness of the first point cloud data.

A fifth aspect provides an electronic device, which may include a memory and a processor. The memory may store computer programs capable of running in the processor. The processor may execute the computer programs to implement the operations in the method of the above first aspect, or implement the operations in the method of the above second aspect.

A sixth aspect provides a computer storage medium, which may store one or more programs. The one or more programs may be executed by one or more processors to implement the operations in the method of the above first aspect, or implement the operations in the method of the above second aspect.

A seventh aspect provides a computer program product, which comprises computer-executable instructions. When the computer-executable instructions run in a processor of a device, the processor executes the operations in the method of the above first aspect, or executes the operations in the method of the above second aspect.

### BRIEF DESCRIPTION OF THE DRAWINGS

In order to describe the technical solutions of the embodiments of the disclosure more clearly, the drawings required to be used in descriptions about the embodiments or a conventional art will be simply introduced below. It is apparent that the drawings described below are only some embodiments of the disclosure. Other drawings may further be obtained by those of ordinary skill in the art according to these drawings without creative work.

FIG. 1 is a structure diagram of a monitoring and alarming system according to embodiments of the disclosure.

FIG. 2 is an implementation flowchart of a method for generating point cloud encoder according to embodiments of the disclosure.

FIG. 3 is an implementation flowchart of another method for generating point cloud encoder according to embodiments of the disclosure.

FIG. 4 is an implementation flowchart of another method for generating point cloud encoder according to embodiments of the disclosure.

FIG. 5 is an implementation flowchart of another method for generating point cloud encoder according to embodiments of the disclosure.

FIG. 6 is an implementation flowchart of a method for generating point cloud data according to embodiments of the disclosure.

FIG. 7 is a schematic diagram of an architecture of a Probabilistic Modeling Network (PMNet) according to embodiments of the disclosure.

FIG. 8 is a composition structure diagram of an apparatus for generating point cloud encoder according to embodiments of the disclosure.

FIG. 9 is a composition structure diagram of an apparatus for generating point cloud data according to embodiments of the disclosure.

FIG. 10 is a schematic diagram of a hardware entity of an electronic device according to embodiments of the disclosure.

### DETAILED DESCRIPTION

In the embodiments of the disclosure, since the weight of the first encoder is regulated based on the first probability distribution of the first point cloud data and the second probability distribution of the second point cloud data, the target weight, obtained by training, of the first encoder may be adapted to both the first point cloud data with relatively low completeness and the second point cloud data with relatively high completeness, and furthermore, the point cloud encoder generated based on the target weight, obtained by regulation, of the first encoder may guide completion of the point cloud data with relatively low completeness to obtain the realistic and complete point cloud data to ensure that the point cloud data obtained by completion is more complete and may express the real object more accurately.

The technical solutions of the disclosure will be specifically described below through the embodiments and in combination with the drawings in detail. The following specific embodiments may be combined. The same or similar concepts or processes will not be elaborated in some embodiments.

It is to be noted that, in the embodiments of the disclosure, “first”, “second” and the like are adopted to distinguish similar objects and not intended to describe a target sequence or order. In addition, the technical solutions recorded in the embodiments of the disclosure may be freely combined without conflicts.

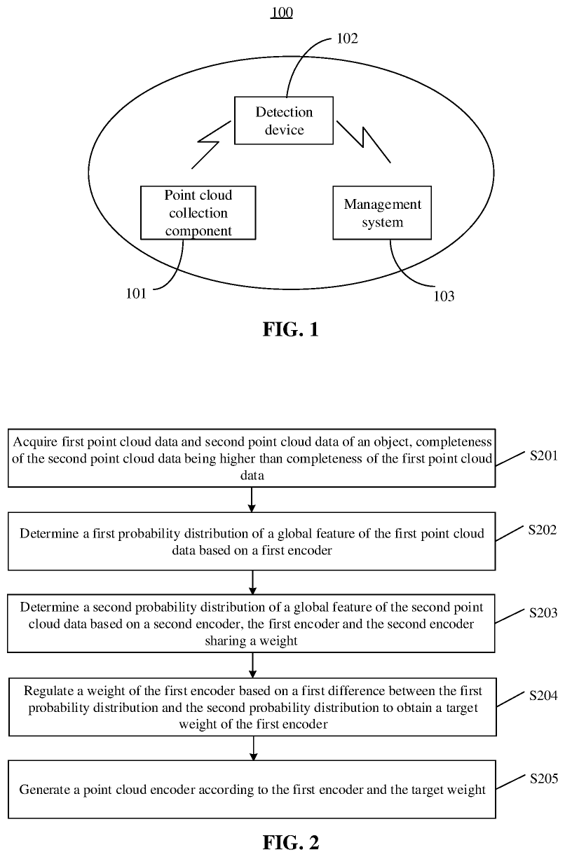

FIG. 1 is a structure diagram of a monitoring and alarming system according to embodiments of the disclosure. As shown in FIG. 1, the system 100 may include a point cloud collection component 101, a detection device 102 and a management system 103.

The point cloud collection component 101 may be in communication connection with the detection device 102. The detection device 102 may be connected with a server, so that the server may correspondingly control the detection device 102, and the detection device 102 may also use service provided by the server. In some implementation modes, the detection device 102 may correspond to only one point cloud collection component 101. In some other implementation modes, the detection device 102 may correspond to multiple point cloud collection components 101. In some implementation modes, the detection device 102 may be arranged in a game place. For example, the detection device 102 may be connected with a server in the game place. In some other implementation modes, the detection device 102 may be arranged in a cloud.

The detection device 102 may analyze a game table in the game place and a game player at the game table based on a real-time point cloud collected by the point cloud collection component 101 to determine whether an action of the game player conforms to a rule or is proper or not.

The detection device 102 may be in communication connection with the management system 103. Under the condition that the detection device 102 determines that the action of the game player is improper, the detection device 102 may send target alarming information to the management system 103 for the game table corresponding to the game player that does the improper action such that the management system 103 may give an alarm corresponding to the target alarming information to alarm the game player through the game table.

In some scenarios, the detection device 102 may also be connected with a camera component arranged in the game place to fuse the point cloud and image data for more accurate analysis. Compared with a two-dimensional picture or video, a point cloud data format may avoid loss of distance information between an object and a sensor, namely three-dimensional position information of the object in a space may be obtained. Ambiguities (for example, an ambiguity of a position of a human body in a three-dimensional space) brought by the two-dimensional picture or video may be avoided by a point cloud. Therefore, for determining whether the action or behavior of the game player conforms the game rule more accurately, three-dimensional point cloud data is acquired through the point cloud collection component 101. However, the collected point cloud data is usually sparse and incomplete. Completing the collected incomplete point cloud data to generate a relatively complete shape may be implemented through a depth network model. How to determine a weight of the model to complete the collected point cloud data of the object to obtain point cloud data with relatively high completeness is a problem urgent to be solved by technicians.

A deep learning model for point cloud completion usually consists of two parts, including a network structure for generating a rough point cloud and a network structure for performing detail boosting on such a basis to generate a final point cloud. The embodiments of the disclosure mainly concern a method for generating a point cloud encoder in the network structure for generating the rough point cloud.

In a related art, an existing network structure for generating a rough point cloud usually includes an encoder and a decoder, and an input of the encoder is an incomplete point cloud, while an output is a representation of the point cloud. The representation is taken as an input of the decoder, and the decoder generates a rough complete point cloud according to the representation. The method has the shortcoming that the generated rough point cloud is usually similar to a general shape of a class that the point cloud belongs to but details in the input incomplete point cloud are neglected. The representation of the point cloud may be feature information of the point cloud.

The embodiments of the disclosure provide a composite network structure for generating a rough point cloud. The network structure includes two parallel paths. One path is a point cloud reconstruction path, and the other path is a point cloud completion path. The point cloud reconstruction path is used for training only and thus has no influence on a point cloud completion speed in a practical application. The point cloud completion path, after taking an incomplete point cloud as an input, extracts a representation of the incomplete point cloud and a distribution of a complete point cloud generated according to a representation by use of an encoder. Then, a decoder forms a rough point cloud of a complete shape based on the distribution of the complete point cloud.

FIG. 2 is an implementation flowchart of a method for generating point cloud encoder according to embodiments of the disclosure. As shown in FIG. 2, the method is applied to an apparatus for generating point cloud encoder. The method includes the following operations.

In S201, first point cloud data and second point cloud data of an object are acquired, completeness of the second point cloud data being higher than completeness of the first point cloud data.

The apparatus for generating point cloud encoder may be a neural network apparatus. A neural network may be a PMNet. The apparatus for generating point cloud encoder may be deployed in a chip or a processor, etc. The chip or the processor may be applied to at least one of the following devices: a mobile phone, a pad, a computer with a wireless transceiver function, a palm computer, a desktop computer, a personal digital assistant, a portable media player, an intelligent speaker, a navigation device, a wearable device such as a smart watch, smart glasses and a smart necklace, a pedometer, a digital Television (TV), a Virtual Reality (VR) terminal device, an Augmented Reality (AR) terminal device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home and a vehicle, vehicle-mounted device or vehicle-mounted module in an Internet of vehicles system, etc.

The first point cloud data may be point cloud data obtained by shooting the object through a laser radar or a depth camera. In some implementation modes, the apparatus for generating point cloud encoder may determine the first point cloud data from an image, shot by the laser radar or the depth camera, of a certain object. In some other implementation modes, the apparatus for generating point cloud encoder may capture an image from a video, shot by the laser radar or the depth camera, of a certain object to determine the first point cloud data. The object may be anything that exists. For example, in some implementation modes, the object may be a game table in a game place, or, the game table in the game place and at least one game player around the game table. In some other implementation modes, the object may be game currency or some parts (for example, the hand and/or the head) of the game player. In some implementation modes, the first point cloud data may correspond to point cloud data of one image. In some other implementation modes, the first point cloud data may correspond to point cloud data of multiple images. The multiple images may be all images required by determination of a target weight.

The first point cloud data may be incomplete point cloud data. The first point cloud data may include a large number of points, and each point has an initial feature. An initial feature of the first point cloud data may include the initial feature of each point in the first point cloud data.

In S202, a first probability distribution of a global feature of the first point cloud data is determined based on a first encoder.

In the embodiments of the disclosure, both the first encoder and a second encoder may be Variational Auto-Encoders (VAEs). In addition, both the following first decoder and second decoder may be variational auto-decoders.

The first encoder may receive the initial feature of the first point cloud data, calculate the initial feature of the first point cloud data based on initial weight information of the first encoder and output the first probability distribution of the global feature of the first point cloud data. The first probability distribution may be a conditional probability distribution. The first probability distribution may be a probability distribution of the global feature of the first point cloud data when the initial feature of the first point cloud data is fixed. When the initial feature of the first point cloud is X and the global feature is z_{g}, the first probability distribution is p_{Ψ}(z_{g}|X) A weight of the first encoder may be an initial weight of an encoder of a point cloud completion path.

In S203, a second probability distribution of a global feature of the second point cloud data is determined based on a second encoder, the first encoder and the second encoder sharing a weight.

In another embodiment, the second point cloud data may also be called real point cloud data.

In the embodiments of the disclosure, the initial feature of the first point cloud data or the second point cloud data may include at least one of: three-dimensional coordinate information, an echo count, strength information, a class, Red Green Blue (RGB), a scanning angle, a scanning direction, etc. The second encoder may receive the initial feature of the second point cloud data, calculate the initial feature of the second point cloud data based on weight information of the second encoder and output the second probability distribution of the global feature of the second point cloud data. The second probability distribution may be a conditional probability distribution. The second probability distribution may be a probability distribution of the global feature of the second point cloud data when the initial feature of the second point cloud data is fixed. When an initial feature of a sample point cloud is Y and a global feature is z_{g}, the second probability distribution is q_{ϕ}(z_{g}|Y). A weight of the second encoder may be an initial weight of an encoder of a point cloud reconstruction path.

An implementation mode of weight sharing of the first encoder and the second encoder is that the weight of the first encoder and the weight of the second encoder are the same before training, in a training process and after the training process.

In S204, a weight of the first encoder is regulated based on a first difference between the first probability distribution and the second probability distribution to obtain a target weight of the first encoder.

In some implementation modes, the apparatus for generating point cloud encoder may train the weight of the first encoder based on the first probability distribution and the second probability distribution to make the first difference between the first probability distribution and the second probability distribution smaller than a preset value to obtain the target weight of the first encoder.

After the target weight of the first encoder is obtained, the apparatus for generating point cloud encoder may determine the probability distribution of the global feature of the first point cloud data based on the target weight and then generate complete point cloud data based on the probability distribution of the global feature of the first point cloud data and the weight of the first encoder. The complete point cloud data may be rough complete point cloud data corresponding to the first point cloud data.

In some other implementation modes, the apparatus for generating point cloud encoder may also train the weight of the first encoder to obtain the target weight of the first encoder and then generate the rough complete point cloud data based on the probability distribution of the global feature of the first point cloud data and the target weight of the first encoder.

In S205, a point cloud encoder is generated according to the first encoder and the target weight.

In some implementation modes, a structure in the point cloud encoder is the same as a structure of the first encoder, and a weight in the point cloud encoder is the target weight.

In the embodiments of the disclosure, since the weight of the first encoder is regulated based on the first probability distribution of the first point cloud data and the second probability distribution of the second point cloud data, the target weight, obtained by training, of the first encoder may be adapted to both the first point cloud data with relatively low completeness and the second point cloud data with relatively high completeness, and furthermore, the point cloud encoder generated based on the target weight, obtained by regulation, of the first encoder may guide completion of the point cloud data with relatively low completeness to obtain realistic and complete point cloud data to ensure that the point cloud data obtained by completion is more complete and may express the real object more accurately.

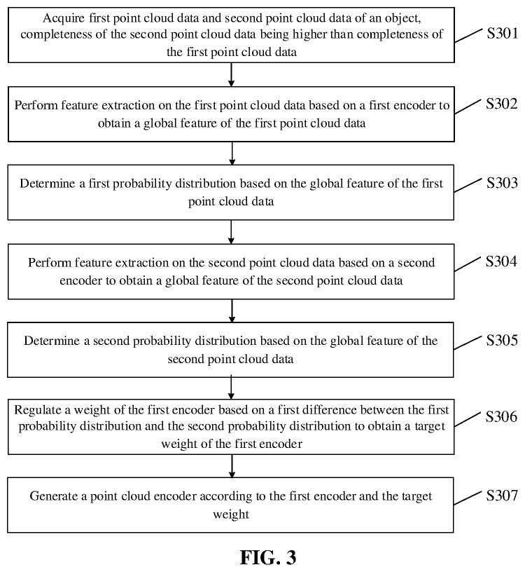

FIG. 3 is an implementation flowchart of another method for generating point cloud encoder according to embodiments of the disclosure. As shown in FIG. 3, the method is applied to an apparatus for generating point cloud encoder. The method includes the following operations.

In S301, first point cloud data and second point cloud data of an object are acquired, completeness of the second point cloud data being higher than completeness of the first point cloud data.

In S302, feature extraction is performed on the first point cloud data based on a first encoder to obtain a global feature of the first point cloud data.

A weight of the first encoder may include a first sub weight configured to increase a dimension of an extracted feature from a first dimension to a second dimension. An initial feature of the first point cloud data includes an initial feature of each point in the first point cloud data.

S302 may be implemented in the following manner: linear transformation and/or nonlinear transformation are/is performed on the initial feature of each point in the first point cloud data based on the first sub weight of the first encoder to obtain a first feature of each point in the first point cloud data; a maximum value of the first feature of each point in the first point cloud data in each feature dimension is extracted to obtain a fused feature of the first point cloud data; the first feature of each point in the first point cloud data and the fused feature of the first point cloud data are concatenated to obtain a second feature of each point in the first point cloud data; and the global feature of the first point cloud data is determined based on the second feature of each point in the first point cloud data.

The first sub weight of the first encoder may include a weight in a first perceptron and a weight in a second perceptron. In some implementation modes, the operation that linear transformation and/or nonlinear transformation are/is performed on the initial feature of each point in the first point cloud data based on the first sub weight of the first encoder to obtain the first feature of each point in the first point cloud data may include that: the initial feature of each point in the first point cloud data is input to the first perceptron, and the first perceptron calculates the initial feature of each point in the first point cloud data through the weight of the first perceptron to obtain and output, to the second perceptron, a fourth feature of each point in the first point cloud data; and then the second perceptron calculates the fourth feature of each point in the first point cloud data through the weight in the second perceptron to obtain and output, to a first Maxpool module, the first feature of each point in the first point cloud data such that the first Maxpool module extracts the maximum value of the first feature of each point in the first point cloud data in each feature dimension to obtain the fused feature of the first point cloud data.

In the embodiments of the disclosure, any perceptron (including any one of first to eighth perceptions) may be a Multilayer Perceptron (MLP). The MLP may be a Shared MLP. The MLP is a feedforward artificial neural network and maps a group of input vectors to a group of output vectors. Any perceptron may increase a dimension of an input feature, reduce the dimension of the input feature or keep the dimension of the input feature unchanged. In some implementation modes, the first perceptron is configured to convert the input feature to a 128-dimensional feature, and the second perceptron is configured to convert the input feature to a 256-dimensional feature. A dimension of the fused feature of the first point cloud data may be 256.

A dimension of the first feature of each point in the first point cloud data may be the same as the dimension of the fused feature of the first point cloud data. For example, the dimension of the first feature of each point in the first point cloud data is M, the dimension of the fused feature of the first point cloud data is M, and a dimension obtained after the first feature of each point in the first point cloud data and the fused feature of the first point cloud data are concatenated is 2×M. In some implementation modes, a dimension of the second feature of each point in the first point cloud data is also 2×M. In some other implementation modes, dimension compression may be performed on obtained 2×M such that the obtained dimension of the second feature of each point in the first point cloud data is M.

Accordingly, linear transformation and/or nonlinear transformation may be performed on the initial feature of each point in the first point cloud data to acquire features of a higher dimension in the first point cloud data, so that deeper features in the first point cloud data may be mined, and furthermore, realistic and complete point cloud data may be obtained by completion better through a target weight, obtained by training, of the first encoder. In addition, since the completeness of the first point cloud data is relatively low, which results in a relatively small information amount, the first feature of each point in the first point cloud data and the fused feature of the first point cloud data are concatenated to obtain the second feature of each point in the first point cloud data, so that the obtained global feature of the first point cloud data may represent a global condition of the first point cloud data well.

In S303, a first probability distribution is determined based on the global feature of the first point cloud data.

The weight of the first encoder may also include a second sub weight configured to increase the dimension of the extracted feature from the second dimension to a third dimension.

S303 may be implemented in the following manner: linear transformation and/or nonlinear transformation are/is performed on the second feature of each point in the first point cloud data based on the second sub weight of the first encoder to obtain a third feature of each point in the first point cloud data; and a maximum value of the third feature of each point in the first point cloud data in each feature dimension is extracted to obtain the global feature of the first point cloud data.

The second sub weight of the first encoder may include a weight in a third perceptron and a weight in a fourth perceptron. In some implementation modes, the operation that linear transformation and/or nonlinear transformation are/is performed on the second feature of each point in the first point cloud data based on the second sub weight of the first encoder to obtain the third feature of each point in the first point cloud data may include that: the second feature of each point in the first point cloud data is input to the third perceptron, and the third perceptron calculates the second feature of each point in the first point cloud data through the weight of the third perceptron to obtain and output, to the fourth perceptron, a fifth feature of each point in the first point cloud data; and then the fourth perceptron calculates the fifth feature of each point in the first point cloud data through the weight in the fourth perceptron to obtain and output, to a second Maxpool module, the third feature of each point in the first point cloud data such that the second Maxpool module obtains the global feature of the first point cloud data.

The third perceptron is configured to convert the input feature to a 512-dimensional feature, and the fourth perceptron is configured to convert the input feature to a 1,024-dimensional feature. The global feature of the first point cloud data is also a 1,024-dimensional feature.

Accordingly, the third feature of each point in the first point cloud data is obtained by linear transformation and/or nonlinear transformation, so that a correlative feature of each point in the first point cloud data may further be acquired, the global feature of the first point cloud data is further obtained based on the third feature of each point in the first point cloud data, and the realistic and complete point cloud data may be obtained by completion better through the target weight, obtained by training, of the first encoder.

In S304, feature extraction is performed on the second point cloud data based on a second encoder to obtain a global feature of the second point cloud data.

A weight of the second encoder may include a third sub weight configured to increase a dimension of an extracted feature from the first dimension to the second dimension. An initial feature of the second point cloud data may include an initial feature of each point in the second point cloud data.

S304 may be implemented in the following manner: linear transformation and/or nonlinear transformation are/is performed on the initial feature of each point in the second point cloud data based on the third sub weight of the second encoder to obtain a first feature of each point in the second point cloud data; a maximum value of the first feature of each point in the second point cloud data in each feature dimension is extracted to obtain a fused feature of the second point cloud data; element-wise multiplication is performed on the first feature of each point in the second point cloud data and the fused feature of the second point cloud data to obtain a second feature of each point in the second point cloud data; and the global feature of the second point cloud data is determined based on the second feature of each point in the second point cloud data.

The third sub weight of the second encoder may include a weight in a fifth perceptron and a weight in a sixth perceptron. In some implementation modes, the operation that linear transformation and/or nonlinear transformation are/is performed on the initial feature of each point in the second point cloud data based on the third sub weight of the second encoder to obtain the first feature of each point in the second point cloud data may include that: the initial feature of each point in the second point cloud data is input to the fifth perceptron, and the fifth perceptron calculates the initial feature of each point in the second point cloud data through the weight of the fifth perceptron to obtain and output, to the sixth perceptron, a fourth feature of each point in the second point cloud data; and then the sixth perceptron calculates the fourth feature of each point in the second point cloud data through the weight in the sixth perceptron to obtain and output, to a third Maxpool module, the first feature of each point in the second point cloud data such that the third Maxpool module determines the fused feature of the second point cloud data.

A dimension of the first feature of each point in the second point cloud data may be M, a dimension of the fused feature of the second point cloud data may be M, and a dimension obtained after element-wise multiplication is performed on the first feature of each point in the second point cloud data and the fused feature of the second point cloud data may be M. In some implementation modes, the second feature of each point in the second point cloud data is an M-dimensional feature obtained by element-wise multiplication. In some other implementation modes, the second feature of each point in the second point cloud data may be a 2×M-dimensional feature obtained by performing dimension extension on the M-dimensional feature obtained by element-wise multiplication. In the embodiments of the disclosure, a dimension of the second feature of each point in the second point cloud data is the same as the dimension of the second feature of each point in the first point cloud data.

Accordingly, linear transformation and/or nonlinear transformation may be performed on the initial feature of each point in the second point cloud data to acquire features of a higher dimension in the second point cloud data, so that deeper features in the second point cloud data may be mined, and furthermore, the realistic and complete point cloud data may be obtained by completion better through the target weight, obtained by training, of the first encoder. In addition, since the completeness of the second point cloud data is high, resulting in a relatively large information amount, element-wise multiplication is performed on the first feature of each point in the second point cloud data and the fused feature of the second point cloud data to obtain the second feature of each point in the second point cloud data, and furthermore, the obtained global feature of the second point cloud data may represent a global condition of the second point cloud data well.

In S305, a second probability distribution is determined based on the global feature of the second point cloud data.

The weight of the second encoder may also include a fourth sub weight configured to increase the dimension of the extracted feature from the second dimension to a third dimension.

S305 may be implemented in the following manner: linear transformation and/or nonlinear transformation are/is performed on the second feature of each point in the second point cloud data based on the fourth sub weight of the second encoder to obtain a third feature of each point in the second point cloud data; and a maximum value of the third feature of each point in the second point cloud data in each feature dimension is extracted to obtain the global feature of the second point cloud data.

The fourth sub weight of the second encoder may include a weight of a seventh perceptron and a weight of an eighth perceptron. In some implementation modes, the operation that linear transformation and/or nonlinear transformation are/is performed on the second feature of each point in the second point cloud data based on the fourth sub weight of the second encoder to obtain the third feature of each point in the second point cloud data may include that: the second feature of each point in the second point cloud data is input to the seventh perceptron, and the seventh perceptron calculates the second feature of each point in the second point cloud data through the weight of the seventh perceptron to obtain and output, to the eighth perceptron, a fifth feature of each point in the second point cloud data; and then the eighth perceptron calculates the fifth feature of each point in the second point cloud data through the weight in the eighth perceptron to obtain and output, to a fourth Maxpool module, the third feature of each point in the second point cloud data such that the fourth Maxpool module obtains the global feature of the second point cloud data.

Accordingly, the third feature of each point in the second point cloud data is obtained by linear transformation and/or nonlinear transformation, so that a correlative feature of each point in the second point cloud data may further be acquired, the global feature of the second point cloud data is further obtained based on the third feature of each point in the second point cloud data, and the realistic and complete point cloud data may be obtained by completion better through the target weight, obtained by training, of the first encoder.

The weights in the fifth perceptron, the sixth perceptron, the seventh perceptron and the eighth perceptron may be the same as the weights in or shared with the first perceptron, the second perceptron, the third perceptron and the fourth perceptron.

In S306, a weight of the first encoder is regulated based on a first difference between the first probability distribution and the second probability distribution to obtain a target weight of the first encoder.

In S307, a point cloud encoder is generated according to the first encoder and the target weight.

In the embodiments of the disclosure, feature extraction may be performed on the first point cloud data and the second point cloud data according to the first encoder and the second encoder respectively to determine the global feature of the first point cloud data and the global feature of the second point cloud data respectively, so that more features in the first point cloud data and the second point cloud data may be acquired, and furthermore, when the weight of the first encoder is trained, training may be implemented based on more features in the first point cloud data and the second point cloud data to ensure that the realistic and complete point cloud data may be obtained by completion better through the target weight, obtained by training, of the first encoder.

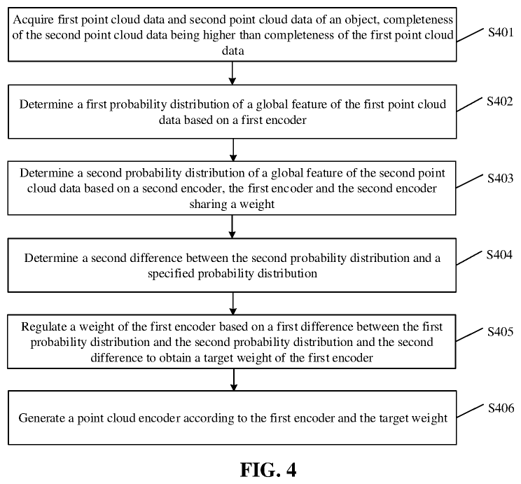

FIG. 4 is an implementation flowchart of another method for generating point cloud encoder according to embodiments of the disclosure. As shown in FIG. 4, the method is applied to an apparatus for generating point cloud encoder. The method includes the following operations.

In S401, first point cloud data and second point cloud data of an object are acquired, completeness of the second point cloud data being higher than completeness of the first point cloud data.

In S402, a first probability distribution of a global feature of the first point cloud data is determined based on a first encoder.

In S403, a second probability distribution of a global feature of the second point cloud data is determined based on a second encoder, the first encoder and the second encoder sharing a weight.

In S404, a second difference between the second probability distribution and a specified probability distribution is determined.

The specified probability distribution may be a Gaussian distribution. For example, the specified probability distribution may be a standard Gaussian distribution. The second difference may be represented through the following formula: KL[q_{ϕ}(z_{g}|Y)∥p(z_{g})], where KL represents a KL divergence, p(z_{g})=N(0,1) is a priori condition for predefining as a Gaussian distribution, and q_{ϕ}(z_{g}|Y) is the second probability distribution.

In S405, a weight of the first encoder is regulated based on a first difference between the first probability distribution and the second probability distribution and the second difference to obtain a target weight of the first encoder.

The first difference may be represented through the following formula:

KL[q_{ϕ}(z_{g}|Y)∥p_{φ}(z_{g}|X)], where KL represents a KL divergence, and p_{φ}(z_{g}|X) is the first probability distribution.

In some implementation modes, the apparatus for generating point cloud encoder may train the weight of the first encoder based on the second difference and the first difference to make the second difference smaller than a first threshold and make the first difference smaller than a second threshold to obtain the target weight of the first encoder.

In S406, a point cloud encoder is generated according to the first encoder and the target weight.

In the embodiments of the disclosure, the weight of the first encoder is regulated based on the second difference between the second probability distribution and the specified probability distribution and the first difference between the first probability distribution and the second probability distribution to make both the first difference and the second difference as small as possible and further make both the first probability distribution and the second probability distribution as close as possible to the specified probability distribution, so that realistic and complete point cloud data may be obtained by completion better through the target weight, obtained by training, of the first encoder.

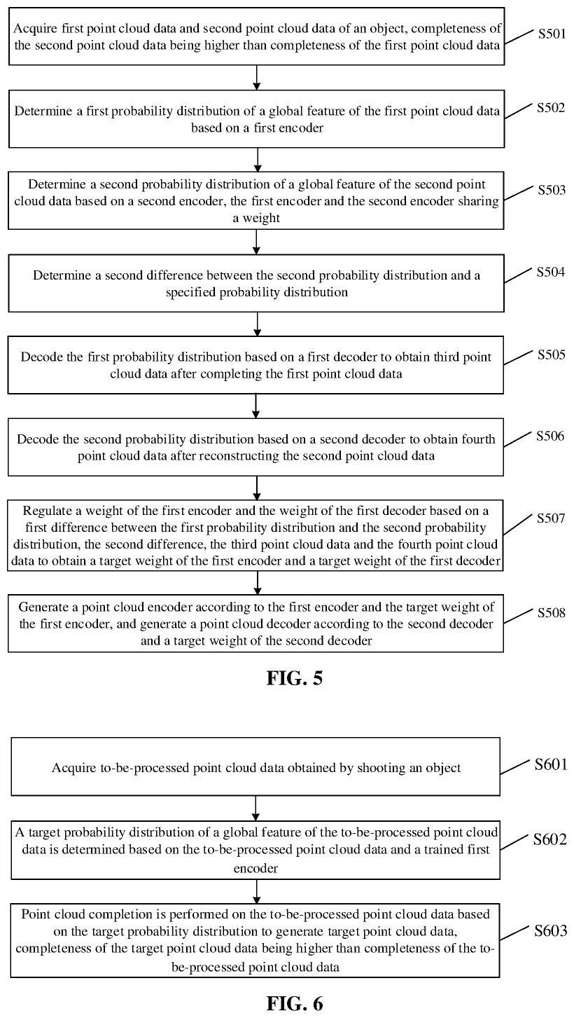

FIG. 5 is an implementation flowchart of another method for generating point cloud encoder according to embodiments of the disclosure. As shown in FIG. 5, the method is applied to an apparatus for generating point cloud encoder. The method includes the following operations.

In S501, first point cloud data and second point cloud data of an object are acquired, completeness of the second point cloud data being higher than completeness of the first point cloud data.

In S502, a first probability distribution of a global feature of the first point cloud data is determined based on a first encoder.

In S503, a second probability distribution of a global feature of the second point cloud data is determined based on a second encoder, the first encoder and the second encoder sharing a weight.

In S504, a second difference between the second probability distribution and a specified probability distribution is determined.

In S505, the first probability distribution is decoded based on a first decoder to obtain third point cloud data after completing the first point cloud data.

In some implementation modes, the first probability distribution may be input to the first decoder such that the first decoder calculates the first probability distribution based on the weight of the first decoder to obtain a feature corresponding to each probability value in the first probability distribution to further obtain the third point cloud data.

In S506, the second probability distribution is decoded based on a second decoder to obtain fourth point cloud data after reconstructing the second point cloud data.

In some implementation modes, the second probability distribution may be input to the second decoder such that the second decoder calculates the second probability distribution based on the weight of the second decoder to obtain a feature corresponding to each probability value in the second probability distribution to further obtain the fourth point cloud data.

The first decoder and the second decoder are configured to convert the input probability distributions into the point cloud data. In an implementation process, the first decoder and the second decoder may include Fully Connected (FC) layers.

In S507, a weight of the first encoder and the weight of the first decoder are regulated based on a first difference between the first probability distribution and the second probability distribution, the second difference, the third point cloud data and the fourth point cloud data to obtain a target weight of the first encoder and a target weight of the first decoder.

In some implementation processes, S507 may be implemented in the following manner: a third difference between the third point cloud data and the second point cloud data is determined; a fourth difference between the fourth point cloud data and the second point cloud data is determined; and the weight of the first encoder and the weight of the first decoder are regulated based on the first difference, the second difference, the third difference and the fourth difference to obtain the target weight of the first encoder and the target weight of the first decoder.

The third difference may be represented through the following formula: E_{P}_{_{data}}_{(X)}Eₚ_{_{φ}}_{(z}_{_{g}}_{|X)}[log p_{θ}^{c}(Y|z_{g})], where E represents an expectation to a function, p_{data}(X) represents a real basic distribution of the first point cloud data, p_{φ} (z_{g}|X) is the first probability distribution, and p_{θ}^{c}(Y|z_{g}) is a decoded distribution of the global feature.

The fourth difference may be represented through the following formula: E_{P}_{_{data}}_{(Y)}E_{q}_{_{ϕ}}_{(z}_{_{g}}_{|Y)}[log p_{θ}^{r}(Y|z_{g})], where p_{data}(Y) represents a real basic distribution of the second point cloud data, q_{ϕ}(z_{g}|Y) is the second probability distribution, and p_{θ}^{r}(Y|z_{g}) is the decoded distribution of the global feature. In the implementation process, ϕ, φ and θ represent different network weights of the corresponding function.

In the implementation process, the apparatus for generating point cloud encoder may train the weight of the first encoder and the weight of the first decoder based on the second difference, the first difference, the third difference and the fourth difference to ensure that the second difference is smaller than a first threshold, the first difference is smaller than a second threshold, the third difference is smaller than a third threshold and the fourth difference is smaller than a fourth threshold or ensure that a sum of the second difference and the fourth difference is smaller than a fifth threshold and a sum of the first difference and the third difference is smaller than a sixth threshold to obtain the target weight of the first encoder and the target weight of the first decoder. Any two thresholds in the first threshold to the sixth threshold may be the same, or, at least two thresholds are different.

In some implementation modes, a loss function configured in a point cloud reconstruction path to train the second encoder and the second decoder may be represented through formula (1):

L_{rec}=λKL[q_{ϕ}(z_{g}|Y)∥p(z_{g})]+Eₚ_{_{data}}_{(Y)}E_{q}_{_{ϕ}}_{(z}_{_{g}}_{|Y)}[Log p_{θ}^{r}(Y|z_{g})] (1).

λ is a weighted parameter.

A loss function configured in a point cloud completion path to train the first encoder and the first decoder may be represented through formula (2):

L_{com}=—λKL[q_{ϕ}(z_{g}|Y)∥p_{φ}(z_{g}|X)]+Eₚ_{_{data}}_{(X)}Eₚ_{_{φ}}_{(z}_{_{g}}_{|X)}[log p_{θ}^{c}(Y|z_{g})] (2).

Accordingly, the weight of the first encoder and the weight of the first decoder are trained based on the second difference, the first difference, the third difference and the fourth difference to make both the first probability distribution and the second probability distribution as close as possible to the specified probability distribution and make both the third point cloud data and the fourth point cloud data as close as possible to the second point cloud data, so that the realistic and complete point cloud data may be obtained by completion better through the target weight of the first encoder and target weight of the first decoder, which are obtained by training.

In S508, a point cloud encoder is generated according to the first encoder and the target weight of the first encoder, and a point cloud decoder is generated according to the second decoder and a target weight of the second decoder.

In the embodiments of the disclosure, since the third point cloud data is determined based on the first probability distribution and the weight of the first decoder and the fourth point cloud data is determined based on the second probability distribution and the weight of the second decoder, the weight of the first encoder and the weight of the first decoder may be trained based on the second difference, the first difference, the second point cloud data and the third point cloud data to ensure that the realistic and complete point cloud data may be obtained by completion better through the target weight of the first encoder and target weight of the first decoder, which are obtained by training.

In some implementation modes, since the third point cloud data is obtained by processing the first point cloud data sequentially through the first encoder and the first decoder based on the weight of the first encoder and the weight of the first decoder and the fourth point cloud data is obtained by processing the second point cloud data sequentially through the second encoder and the second decoder based on the weights of the second encoder and the second decoder, the weight of the first encoder and the weight of the first decoder may be trained by use of the third point cloud data, and the weight of the second encoder and the weight of the second decoder may be trained by use of the fourth point cloud data.

The below is an implementation flowchart of a method for generating point cloud encoder provided in the disclosure. The method is applied to an apparatus cloud point encoder. In the method, after a first probability distribution and the second probability distribution are determined, the following operations may be executed.

Third point cloud data including a feature corresponding to each provability value in the first probability distribution is determined based on the first probability distribution and a weight of a first decoder. Fourth point cloud data including a feature corresponding to each provability value in the second probability distribution is determined based on the second probability distribution and a weight of a second decoder. The first decoder and the second decoder share a weight. A weight of a first encoder and the weight of the first decoder are trained based on the third point cloud data and the fourth point cloud data to obtain a target weight of the first encoder and a target weight of the first decoder. Furthermore, a point cloud encoder is generated according to the first encoder and the target weight of the first encoder, and a point cloud decoder is generated according to the second decoder and a target weight of the second decoder.

In an implementation process, the apparatus for generating point cloud encoder may determine a third difference between the third point cloud data and second point cloud data, determine a fourth difference between the fourth point cloud data and the second point cloud data and train the weight of the first encoder and the weight of the first decoder based on the third difference and the fourth difference to ensure that the third difference is smaller than a third threshold and the fourth difference is smaller than a fourth threshold, thereby obtaining the target weight of the first encoder and the target weight of the first decoder.

In the embodiments of the disclosure, the weight of the first encoder and the weight of the first decoder are trained based on the third point cloud data and the fourth point cloud data to make both the third point cloud data and the fourth point cloud data as close as possible to the second point cloud data, so that a training process is simplified, and realistic and complete point cloud data may be reconstructed through the target weight of the first encoder and target weight of the first decoder, which are obtained by training.

In some implementation modes, S505 may be implemented in the following manner: the first probability distribution is sampled to obtain first sample data; the first probability distribution and the first sample data are merged to obtain a first merged probability distribution; and the first merged probability distribution is decoded based on the first decoder to obtain the third point cloud data after completing the first point cloud data.

In some other implementation modes, S505 may be implemented in the following manner: the first probability distribution is sampled to obtain the first sample data; under the condition that a dimension of the first sample data is smaller than a dimension of the first probability distribution, dimension extension is performed on the first sample data to obtain target sample data of which a dimension is the same as the dimension of the first probability distribution; element-wise addition is performed on the first probability distribution and the target sample data to obtain a second merged probability distribution; and the third point cloud data is determined based on the second merged probability distribution and the weight of the first decoder. For example, under the condition that the first probability distribution includes 1,024 probability values, the first sample data obtained by sampling the first probability distribution may include 1,024 probability values, 512 probability values, 256 probability values, etc.

In some implementation modes, S506 may be implemented in the following manner: the second probability distribution is sampled to obtain second sample data; the first probability distribution and the second sample data are merged to obtain the second merged probability distribution; and the second merged probability distribution is decoded based on the second decoder to obtain the fourth point cloud data after reconstructing the second point cloud data.

In some implementation modes, under the condition that a dimension of the second sample data is the same as the dimension of the first probability distribution, element-wise addition is performed on the first probability distribution and the second sample data to obtain the second merged probability distribution. Under the condition that the dimension of the second probability distribution is smaller than the dimension of the first probability distribution, dimension extension is performed on the second sample data to obtain specified sample data of which a dimension is the same as the dimension of the first probability distribution, and element-wise addition is performed on the first probability distribution and the specified sample data to obtain the second merged probability distribution.

Accordingly, the first probability distribution and the first sample data obtained by sampling the first probability distribution are merged to obtain the first merged probability distribution, and the first merged probability distribution is an enhancement of the first probability distribution, so that the third point cloud data obtained based on the first merged probability distribution may reflect rough complete point cloud data corresponding to the first point cloud data accurately. In addition, the first probability distribution and the second sample data obtained by sampling the second probability distribution are merged to obtain the second merged probability distribution, so that the fourth point cloud data determined based on the second merged probability distribution and the weight of the second decoder not only includes the feature of the first point cloud data but also includes the feature of the second point cloud data, and during training based on the fourth point cloud data, the feature of the first point cloud data and the feature of the second point cloud data may be combined to further ensure that the realistic complete point cloud data may be obtained by completion better through the weight of the first encoder and weight of the first decoder, which are obtained by training.

In the embodiments of the disclosure, a point cloud is obtained through a depth camera or a laser radar, and reconstruction and recovery of an incomplete point cloud are guided through predicting and learning a complete point cloud shape of a probability distribution model to further reconstruct a more realistic point cloud shape, so that the problem of lack of input point cloud details in a generated rough point cloud shape is solved to a certain extent.

A network structure disclosed in the embodiments of the disclosure consists of two parallel paths. During network training, an incomplete point cloud in a set of data is taken as an input of the point cloud completion path, and a complete point cloud corresponding to the incomplete point cloud is taken as an input of the point cloud reconstruction path.

During model training of the point cloud reconstruction path, an VAE takes the complete point cloud corresponding to the incomplete point cloud as the input and learns a conditional probability distribution of a representation generated when the input point cloud is a fixed value therefrom. Then, the VAE may perform point cloud reconstruction according to the representation of the point cloud, and simultaneously learns the conditional probability distribution of the point cloud generated when the input representation is the fixed value. For making the conditional probability distribution of the representation generated when the input point cloud is the fixed value close to a Gaussian distribution, the K-L divergence (describing a similarity between the two distributions) is introduced as a part of the loss function during network training. In addition, for training a point cloud reconstruction capability of the network, the generated complete point cloud is compared with the input real complete point cloud to obtain a similarity, and the similarity is also taken as a part of the loss function.

During model training of the point cloud completion path, parameters of an encoder and decoder of a VAE are the same as parameters in the point cloud reconstruction path, and only parameters of distribution inference layers are different. The point cloud completion path takes an incomplete point cloud as an input and learns a conditional probability distribution of a representation generated when the input point cloud is a fixed value therefrom. For making the conditional probability distribution, learned by the point cloud completion path, of the representation similar to the corresponding conditional probability distribution, learned by the point cloud reconstruction path, of the representation, the K-L divergences of the two distributions are added to the loss function for training. For making a rough complete point cloud generated by the point cloud completion path similar to the real complete point cloud corresponding to the input incomplete point cloud, the similarity between the generated point cloud and the real point cloud is also added to the loss function for training.

In the embodiments of the disclosure, the VAEs and the decoders are adopted to generate the rough point cloud, and the two parallel paths are adopted for network training, one being the point cloud completion path and the other being the point cloud reconstruction path. Therefore, through the two parallel paths, the network may generate the rough complete point cloud according to the input incomplete point cloud. In such a manner, details in the input incomplete point cloud may be preserved greatly, and the problem in the related art that only a general template of a class may be generated in a stage of generating the rough point cloud and information and details in the input incomplete point cloud are neglected is solved.

A method for determining to-be-processed point cloud data based on the target weight, obtained by training, of the first encoder in any abovementioned embodiment, i.e., an application method of the point cloud encoder, according to embodiments of the disclosure will be described below.

FIG. 6 is an implementation flowchart of a method for generating point cloud data according to embodiments of the disclosure. As shown in FIG. 6, the method is applied to an apparatus for generating point cloud data generation. In some implementation modes, the apparatus for generating point cloud data may be the same as or different from the apparatus for generating point cloud encoder. The method includes the following operations.

In S601, to-be-processed point cloud data obtained by shooting an object is acquired.

In S602, a target probability distribution of a global feature of the to-be-processed point cloud data is determined based on the to-be-processed point cloud data and a trained first encoder.

A target weight of the first encoder is obtained by regulating a weight of the first encoder at least based on a first difference between a first probability distribution, determined by the first encoder, of a global feature of first point cloud data and a second probability distribution, determined by a second encoder, of a global feature of second point cloud data. Completeness of the second point cloud data is higher than completeness of the first point cloud data.

In S603, point cloud completion is performed on the to-be-processed point cloud data based on the target probability distribution to generate target point cloud data, completeness of the target point cloud data being higher than completeness of the point cloud data to be processed.

In some implementation modes, S603 may be implemented in the following manner: the target point cloud data is determined based on the target probability distribution and a target weight of a first decoder.

The target weight of the first encoder and the target weight of the first decoder are obtained by training the weight of the first encoder and a weight of the first decoder based on the first probability distribution, the second probability distribution, third point cloud data determined based on the first probability distribution and the weight of the first decoder and fourth point cloud data determined based on the second probability distribution and a weight of a second decoder. The first decoder and the second decoder share a weight.

A manner for obtaining the target weight of the first encoder and the target weight of the first decoder may refer to the descriptions in any one of abovementioned involved embodiments and will not be elaborated herein.

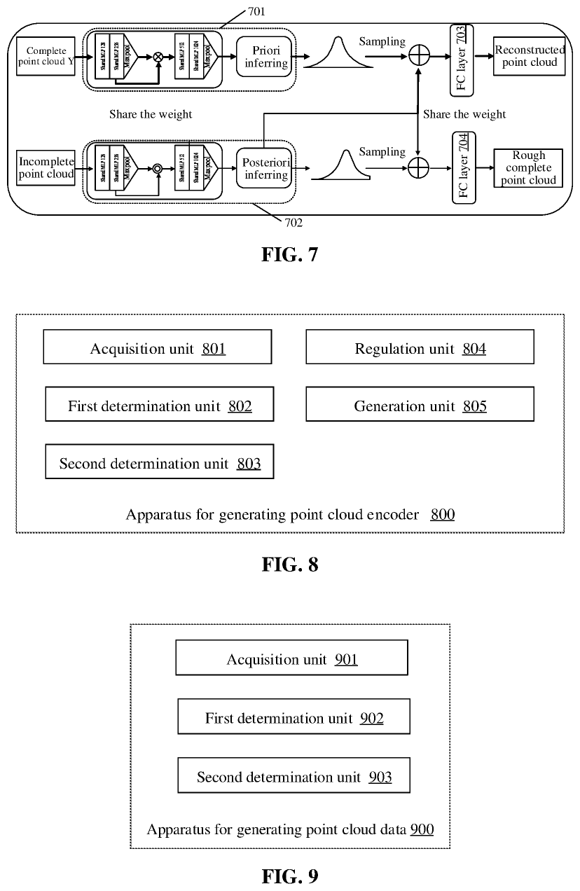

FIG. 7 is a schematic diagram of an architecture of a PMNet according to embodiments of the disclosure. As shown in FIG. 7, the architecture of the PMNet includes two parallel lines, i.e., an upper reconstruction path for a complete point cloud Y corresponding to an incomplete point cloud and a lower completion path for the incomplete point cloud X.

In the upper reconstruction path, the complete point cloud Y (corresponding to the second point cloud data in the abovementioned embodiments) corresponding to the incomplete point cloud (corresponding to the first point cloud data in the abovementioned embodiments) is taken as an input such that a conditional probability distribution (corresponding to the second probability distribution) of a feature of the point cloud when the input point cloud is a fixed value is learned therefrom. For example, the complete point cloud Y is input to a VAE 701, and the VAE may perform point cloud reconstruction according to the feature of the complete point cloud Y, and simultaneously learns the conditional probability distribution of the point cloud generated when the input representation is the fixed value. For making the conditional probability distribution of the representation generated when the input point cloud is the fixed value close to a Gaussian distribution, a K-L divergence (describing a similarity between the two distributions) is introduced as a part of a loss function during network training.

The complete point cloud Y is input to the VAE 701 and calculated sequentially through two MLPs (a shared MLP128 and a shared MLP256 respectively), then Maxpool is performed, a result obtained by performing element-wise multiplication on a Maxpool result and a result obtained after calculation of the two MLPs, is calculated sequentially through two MLPs (a shared MLP512 and a shared MLP1,024 respectively), and Maxpool is performed to obtain a global feature of complete point cloud data. Then, priori inferring is performed based on the global feature of the complete point cloud data and an initial feature of the complete point cloud data to obtain a second probability distribution.

In the lower completion path, the incomplete point cloud X is taken as an input such that a conditional probability distribution of a feature of the point cloud generated when the input point cloud is a fixed value is learned therefrom. For making the conditional probability distribution, learned by the point cloud completion path, of the feature similar to the corresponding conditional probability distribution, learned by the point cloud reconstruction path, of the feature, a K-L divergence of the two distributions is added to the trained loss function.

The incomplete point cloud X is input to a VAE 702 (here, parameters of an encoder and decoder of the VAE 702 are the same as those of the VAE 701) and calculated sequentially through two MLPs (a shared MLP128 and a shared MLP256 respectively), then Maxpool is performed, a result obtained by concatenating a Maxpool result and a result obtained after calculation of the two MLPs is calculated sequentially through two MLPs (a shared MLP512 and a shared MLP1,024 respectively), and Maxpool is performed to obtain a global feature of incomplete point cloud data X. Then, posteriori inferring is performed based on the global feature of the incomplete point cloud data X and an initial feature of the incomplete point cloud data X to obtain a first probability distribution.

In the upper reconstruction path, the second probability distribution may be sampled, element-wise addition is performed on a sampling result and the first probability distribution, and a result obtained by element-wise addition is input to an FC layer 703, thereby outputting a reconstructed point cloud (corresponding to the fourth point cloud data) through the FC layer 703.

In the lower completion path, the first probability distribution may be sampled, element-wise addition is performed on a sampling result and the first probability distribution, and a result obtained by element-wise addition is input to an FC layer 704, thereby outputting a rough complete point cloud (corresponding to the third point cloud data) through the FC layer 704.

After the reconstructed point cloud and the rough complete point cloud are obtained, it is necessary to train a parameter in the PMNet. For example, a parameter in the shared MLP (corresponding to the weight of the first encoder) and a parameter of the FC layer (corresponding to the weight of the first decoder) are trained. Since the first encoder and the second encoder share a weight, and the first decoder and the second decoder share a weight, the rough complete point cloud obtained in a training process of training the weight of the first encoder and the weight of the second encoder is increasingly close to the complete point cloud Y, and furthermore, the rough complete point cloud obtained by roughly completing the incomplete point cloud X may be obtained. After the rough complete point cloud is obtained, an accurate complete point cloud may be determined based on the rough complete point cloud.

In some implementation modes, the incomplete point cloud X may be concatenated with the finally obtained rough complete point cloud, and point cloud data obtained by concatenation is input to a Relational Enhancement Network (RENet), thereby obtaining the accurate complete point cloud. The RENet may implement a hierarchical encoder-decoder system structure through Edge-preserved Pooling (EP) and Edge-preserved Unpooling (EU) modules. The rough complete point cloud and the incomplete point cloud are taken as an input of a hierarchical encoder. In the hierarchical encoder, a feature of input point cloud data is encoded sequentially through Residual Point Selective Kernel (R-PSK) 64, R-PSK128, R-PSK256 and R-PSK512 to finally obtain point cloud feature data of which a point cloud feature dimension is 512. An output result of the R-PSK is processed through multiple layers of EP to implement hierarchical encoding. An output result of the encoder is input to an FC layer, and an output result of the FC layer is fused with the output result of the R-PSK512 to extend the feature dimension. A fusion result is decoded through a hierarchical decoder, and is processed through multiple layers of EU at the hierarchical decoder to implement hierarchical decoding, thereby obtaining an output result of R-PSK64. Finally, the output result of the R-PSK64 is processed through shared MLPs to obtain a final accurate point cloud structure.

In such a manner, point features may be extended by use of edge sensing feature extension modules to generate a high-resolution complete point cloud with predicted accurate local details. Therefore, accurate details may be generated by use of a multi-scale structural relation. The R-PSK module is configured to perform further feature extraction on an initial feature of each point in the point cloud data input to the RENet and output a target feature of each point.

Based on the abovementioned embodiments, embodiments of the disclosure provide an apparatus for generating point cloud encoder. Each unit of the apparatus and each module of each unit may be implemented through a processor in an electronic device.

FIG. 8 is a composition structure diagram of an apparatus for generating point cloud encoder according to embodiments of the disclosure. As shown in FIG. 8, the apparatus for generating point cloud encoder 800 includes: an acquisition unit 801, configured to acquire first point cloud data and second point cloud data of an object, completeness of the second point cloud data being higher than completeness of the first point cloud data; a first determination unit 802, configured to determine a first probability distribution of a global feature of the first point cloud data based on a first encoder; a second determination unit 803, configured to determine a second probability distribution of a global feature of the second point cloud data based on a second encoder, the first encoder and the second encoder sharing a weight; a regulation unit 804, configured to regulate a weight of the first encoder based on a first difference between the first probability distribution and the second probability distribution to obtain a target weight of the first encoder; and a generation unit 805, configured to generate a point cloud encoder according to the first encoder and the target weight.

In some embodiments, the first determination unit 802 is further configured to perform feature extraction on the first point cloud data based on the first encoder to obtain the global feature of the first point cloud data and determine the first probability distribution based on the global feature of the first point cloud data. The second determination unit is further configured to perform feature extraction on the second point cloud data based on the second encoder to obtain the global feature of the second point cloud data and determine the second probability distribution based on the global feature of the second point cloud data.

In some embodiments, the weight of the first encoder includes a first sub weight configured to increase a dimension of an extracted feature from a first dimension to a second dimension. The first determination unit 802 is further configured to perform linear transformation and/or nonlinear transformation on an initial feature of each point in the first point cloud data based on the first sub weight of the first encoder to obtain a first feature of each point in the first point cloud data, extract, in each feature dimension, a maximum value of the first feature of each point in the first point cloud data to obtain a fused feature of the first point cloud data, concatenate the first feature of each point in the first point cloud data and the fused feature of the first point cloud data to obtain a second feature of each point in the first point cloud data and determine the global feature of the first point cloud data based on the second feature of each point in the first point cloud data.

In some embodiments, the weight of the first encoder further includes a second sub weight configured to increase the dimension of the extracted feature from the second dimension to a third dimension. The first determination unit 802 is further configured to perform linear transformation and/or nonlinear transformation on the second feature of each point in the first point cloud data based on the second sub weight of the first encoder to obtain a third feature of each point in the first point cloud data and extract, in each feature dimension, a maximum value of the third feature of each point in the first point cloud data to obtain the global feature of the first point cloud data.

In some embodiments, a weight of the second encoder includes a third sub weight configured to increase a dimension of an extracted feature from the first dimension to the second dimension. The second determination unit 803 is further configured to perform linear transformation and/or nonlinear transformation on an initial feature of each point in the second point cloud data based on the third sub weight of the second encoder to obtain a first feature of each point in the second point cloud data, extract, in each feature dimension, a maximum value of the first feature of each point in the second point cloud data to obtain a fused feature of the second point cloud data, perform element-wise multiplication on the first feature of each point in the second point cloud data and the fused feature of the second point cloud data to obtain a second feature of each point in the second point cloud data and determine the global feature of the second point cloud data based on the second feature of each point in the second point cloud data.

In some embodiments, the weight of the second encoder further includes a fourth sub weight configured to increase the dimension of the extracted feature from the second dimension to the third dimension. The second determination unit 803 is further configured to perform linear transformation and/or nonlinear transformation on the second feature of each point in the second point cloud data based on the fourth sub weight of the second encoder to obtain a third feature of each point in the second point cloud data and extract, in each feature dimension, a maximum value of the third feature of each point in the second point cloud data to obtain the global feature of the second point cloud data.

In some embodiments, the regulation unit 804 is further configured to determine a second difference between the second probability distribution and a specified probability distribution and regulate the weight of the first encoder based on the first difference and the second difference to obtain the target weight of the first encoder.

In some embodiments, the regulation unit 804 is further configured to decode the first probability distribution based on a first decoder to obtain third point cloud data after completing the first point cloud data, decode the second probability distribution based on a second decoder to obtain fourth point cloud data after reconstructing the second point cloud data and regulate the weight of the first encoder and the weight of the first decoder based on the first difference, the second difference, the third point cloud data and the fourth point cloud data to obtain the target weight of the first encoder and a target weight of the first decoder.

In some embodiments, the regulation unit 804 is further configured to determine a third difference between the third point cloud data and the second point cloud data, determine a fourth difference between the fourth point cloud data and the second point cloud data and regulate the weight of the first encoder and the weight of the first decoder based on the first difference, the second difference, the third difference and the fourth difference to obtain the target weight of the first encoder and the target weight of the first decoder.

In some embodiments, the regulation unit 804 is further configured to sample the first probability distribution to obtain first sample data, merge the first probability distribution and the first sample data to obtain a first merged probability distribution, decode the first merged probability distribution based on the first decoder to obtain the third point cloud data after completing the first point cloud data, sample the second probability distribution to obtain second sample data, merge the first probability distribution and the second sample data to obtain a second merged probability distribution and decode the second probability distribution based on the second decoder to obtain the fourth point cloud data after reconstructing the second point cloud data.

Based on the abovementioned embodiments, embodiments of the disclosure provide an apparatus for generating point cloud data. Each unit of the apparatus and each module of each unit may be implemented through a processor in an electronic device.

FIG. 9 is a composition structure diagram of an apparatus for generating point cloud data according to embodiments of the disclosure. As shown in FIG. 9, the apparatus for generating point cloud data 900 includes an acquisition unit 901, a first determination unit 902 and a second determination unit 903.

The acquisition unit 901 is configured to acquire to-be-processed point cloud data obtained by shooting an object.

The first determination unit 902 is configured to determine a target probability distribution of a global feature of the to-be-processed point cloud data based on the to-be-processed point cloud data and a trained first encoder.

The second determination unit 903 is configured to perform point cloud completion on the to-be-processed point cloud data based on the target probability distribution to generate target point cloud data, completeness of the target point cloud data being higher than completeness of the to-be-processed point cloud data.

A target weight of the first encoder is obtained by regulating a weight of the first encoder at least based on a first difference between a first probability distribution, determined by the first encoder, of a global feature of first point cloud data and a second probability distribution, determined by a second encoder, of a global feature of second point cloud data. Completeness of the second point cloud data is higher than completeness of the first point cloud data.

In some embodiments, the second determination unit 903 is further configured to determine the target point cloud data based on the target probability distribution and a target weight of a first decoder. The target weight of the first encoder and the target weight of the first decoder are obtained by training the weight of the first encoder and a weight of the first decoder based on the first probability distribution, the second probability distribution, third point cloud data determined based on the first probability distribution and the weight of the first decoder and fourth point cloud data determined based on the second probability distribution and a weight of a second decoder. The first decoder and the second decoder share a weight.

The above descriptions about the apparatus embodiments are similar to descriptions about the method embodiments and beneficial effects similar to those of the method embodiments are achieved. Technical details undisclosed in the apparatus embodiments of the disclosure may be understood with reference to the descriptions about the method embodiments of the disclosure.

It is to be noted that, in the embodiments of the disclosure, when being implemented in form of a software function module and sold or used as an independent product, the point cloud encoder generation method may also be stored in a computer storage medium. Based on such an understanding, the technical solutions of the embodiments of the disclosure substantially or parts making contributions to the related art may be embodied in form of a software product. The computer software product is stored in a storage medium, including a plurality of instructions configured to enable an electronic device to execute all or part of the method in each embodiment of the disclosure. The storage medium includes various media capable of storing program codes such as a U disk, a mobile hard disk, a Read Only Memory (ROM), a magnetic disk or an optical disk. As a consequence, the embodiments of the disclosure are not limited to any specific hardware and software combination.

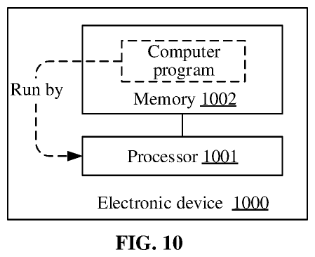

FIG. 10 is a schematic diagram of a hardware entity of an electronic device according to an embodiment of the disclosure. As shown in FIG. 10, the hardware entity of the electronic device 1000 includes a processor 1001 and a memory 1002. The memory 1002 stores a computer program capable of running in the processor 1001. The processor 1001 executes the program to implement the steps in the method of any abovementioned embodiment.

The memory 1002 stores the computer program capable of running in the processor 1001. The memory 1002 is configured to store an instruction and application executable for the processor 1001, may also cache data (for example, image data, audio data, voice communication data and video communication data) to be processed or having been processed by the processor 1201 and each module in the electronic device 1000 and may be implemented through a flash or a Random Access Memory (RAM).

The processor 1001 executes the program to implement the operations of any abovementioned method for generating point cloud encoder or method for generating point cloud data. The processor 1001 usually controls overall operations of the electronic device 1000.

Embodiments of the disclosure provide a computer storage medium, which stores one or more programs. The one or more programs may be executed by one or more processors to implement the operations of the method for generating point cloud data encoder or method for generating point cloud data in any abovementioned embodiment.

It is to be pointed out here that the above descriptions about the storage medium and device embodiments are similar to the descriptions about the method embodiment and beneficial effects similar to those of the method embodiment are achieved. Technical details undisclosed in the storage medium and device embodiments of the disclosure are understood with reference to the descriptions about the method embodiment of the disclosure.

The processor or apparatus for generating point cloud encoder or apparatus for generating point cloud data in the embodiments of the disclosure may be an integrated circuit chip and has a signal processing capability. In an implementation process, each operation of the method embodiments may be completed by an integrated logical circuit of hardware in the processor or an instruction in a software form. The processor may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing unit (CPU), a Graphics Processing Unit (GPU), a Neural-network Processing Unit (NPU), a controller, a microcontroller and a microprocessor. The processor or apparatus for generating the point cloud encoder or apparatus for generating point cloud data may implement or execute each method, operation and logical block diagram disclosed in the embodiments of the disclosure. The universal processor may be a microprocessor or the processor may also be any conventional processor, etc. The operations of the method disclosed in combination with the embodiment of the disclosure may be directly embodied to be executed and completed by a hardware decoding processor or executed and completed by a combination of hardware and software modules in the decoding processor. The software module may be located in a mature storage medium in this field such as a RAM, a flash memory, a ROM, a Programmable ROM (PROM) or Electrically Erasable PROM (EEPROM) and a register. The storage medium is located in a memory, and the processor reads information in the memory and completes the steps of the method in combination with hardware.

It can be understood that the memory or computer storage medium in the embodiments of the disclosure may be a volatile memory or a nonvolatile memory, or may include both the volatile and nonvolatile memories. The nonvolatile memory may be a ROM, a PROM, an Erasable PROM (EPROM), an EEPROM or a flash memory. The volatile memory may be a RAM, and is used as an external high-speed cache. It is exemplarily but unlimitedly described that RAMs in various forms may be adopted, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM) and a Direct Rambus RAM (DR RAM). It is to be noted that the memory of a system and method described in the disclosure is intended to include, but not limited to, memories of these and any other proper types.

Embodiments of the disclosure provide a computer program product. The computer program product comprises computer-executable instructions. When the computer-executable instructions run in a processor of a device, the processor executes the method for generating point cloud data encoder or method for generating point cloud data in any abovementioned embodiment.

It is to be understood that “one embodiment” or “an embodiment” or “the embodiment of the disclosure” or “the abovementioned embodiment” or “some implementation modes” or “some embodiments” mentioned in the whole specification means that specific features, structures or characteristics related to the embodiment are included in at least one embodiment of the disclosure. Therefore, “in one embodiment” or “in an embodiment” or “the embodiment of the disclosure” or “the abovementioned embodiment” or “some implementation modes” or “some embodiments” appearing everywhere in the whole specification does not always refer to the same embodiment. In addition, these specific features, structures or characteristics may be combined in one or more embodiments in any proper manner. It is to be understood that, in each embodiment of the disclosure, a magnitude of a sequence number of each process does not mean an execution sequence and the execution sequence of each process should be determined by its function and an internal logic and should not form any limit to an implementation process of the embodiments of the disclosure. The sequence numbers of the embodiments of the disclosure are adopted not to represent superiority-inferiority of the embodiments but only for description.

In some embodiments provided by the disclosure, it is to be understood that the disclosed device and method may be implemented in another manner. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part of all of the units may be selected according to a practical requirement to achieve the purposes of the solutions of the embodiments.

In addition, each functional unit in each embodiment of the disclosure may be integrated into a processing unit, each unit may also serve as an independent unit and two or more than two units may also be integrated into a unit. The integrated unit may be implemented in a hardware form and may also be implemented in form of hardware and software functional unit.

The methods disclosed in some method embodiments provided in the disclosure may be freely combined without conflicts to obtain new method embodiments.

The characteristics disclosed in some product embodiments provided in the disclosure may be freely combined without conflicts to obtain new product embodiments.

The characteristics disclosed in some method or device embodiments provided in the disclosure may be freely combined without conflicts to obtain new method embodiments or device embodiments.

Those of ordinary skill in the art should know that all or part of the steps of the method embodiment may be implemented by related hardware instructed through a program, the program may be stored in a computer storage medium, and the program is executed to execute the steps of the method embodiment. The storage medium includes: various media capable of storing program codes such as a mobile storage device, a ROM, a magnetic disk or a compact disc.

Or, when being implemented in form of a software function module and sold or used as an independent product, the integrated unit of the disclosure may also be stored in a computer storage medium. Based on such an understanding, the technical solutions of the embodiments of the disclosure substantially or parts making contributions to the related art may be embodied in form of a software product. The computer software product is stored in a storage medium, including a plurality of instructions configured to enable a computer device (which may be a personal computer, a server, a network device or the like) to execute all or part of the method in each embodiment of the disclosure. The storage medium includes: various media capable of storing program codes such as a mobile hard disk, a ROM, a magnetic disk or a compact disc.

In the embodiments of the disclosure, the descriptions about the same steps and the same contents in different embodiments may refer to those in the other embodiments. Singular forms “a/an”, “said” and “the” used in the embodiments and appended claims of the disclosure are also intended to include plural forms unless other meanings are clearly expressed in the context.

It is to be understood that term “and/or” used in the disclosure is only an association relationship describing associated objects and represents that three relationships may exist. For example, A and/or B may represent three conditions: independent existence of A, existence of both A and B and independent existence of B. In addition, character “I” in the disclosure usually represents that previous and next associated objects form an “or” relationship.

It is to be noted that, in each embodiment involved in the disclosure, all the steps may be executed or part of the steps may be executed if a complete technical solution may be formed.

The above is only the implementation mode of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A method for generating point cloud encoder, comprising:
acquiring first point cloud data and second point cloud data of an object, completeness of the second point cloud data being higher than completeness of the first point cloud data;
determining a first probability distribution of a global feature of the first point cloud data based on a first encoder;
determining a second probability distribution of a global feature of the second point cloud data based on a second encoder, the first encoder and the second encoder sharing a weight;
regulating a weight of the first encoder based on a first difference between the first probability distribution and the second probability distribution to obtain a target weight of the first encoder; and
generating a point cloud encoder according to the first encoder and the target weight.

2. The method of claim 1, wherein determining the first probability distribution of the global feature of the first point cloud data based on the first encoder comprises:
performing feature extraction on the first point cloud data based on the first encoder to obtain the global feature of the first point cloud data, and
determining the first probability distribution based on the global feature of the first point cloud data; and
determining the second probability distribution of the global feature of the second point cloud data based on the second encoder comprises:
performing feature extraction on the second point cloud data based on the second encoder to obtain the global feature of the second point cloud data, and
determining the second probability distribution based on the global feature of the second point cloud data.

3. The method of claim 2, wherein the weight of the first encoder comprises a first sub weight configured to increase a dimension of an extracted feature from a first dimension to a second dimension; and
performing feature extraction on the first point cloud data based on the first encoder to obtain the global feature of the first point cloud data comprises:
performing at least one of linear transformation or nonlinear transformation on an initial feature of each point in the first point cloud data based on the first sub weight of the first encoder to obtain a first feature of each point in the first point cloud data,
extracting, in each feature dimension, a maximum value of the first feature of each point in the first point cloud data to obtain a fused feature of the first point cloud data,
concatenating the first feature of each point in the first point cloud data and the fused feature of the first point cloud data to obtain a second feature of each point in the first point cloud data, and
determining the global feature of the first point cloud data based on the second feature of each point in the first point cloud data.

4. The method of claim 3, wherein the weight of the first encoder further comprises a second sub weight configured to increase the dimension of the extracted feature from the second dimension to a third dimension; and determining the global feature of the first point cloud data based on the second feature of each point in the first point cloud data comprises:
performing at least one of linear transformation or nonlinear transformation on the second feature of each point in the first point cloud data based on the second sub weight of the first encoder to obtain a third feature of each point in the first point cloud data, and
extracting, in each feature dimension, a maximum value of the third feature of each point in the first point cloud data to obtain the global feature of the first point cloud data.

5. The method of claim 2, wherein a weight of the second encoder comprises a third sub weight configured to increase a dimension of an extracted feature from a first dimension to a second dimension; and
performing feature extraction on the second point cloud data based on the second encoder to obtain the global feature of the second point cloud data comprises:
performing at least one of linear transformation or nonlinear transformation on an initial feature of each point in the second point cloud data based on the third sub weight of the second encoder to obtain a first feature of each point in the second point cloud data,
extracting, in each feature dimension, a maximum value of the first feature of each point in the second point cloud data to obtain a fused feature of the second point cloud data,
performing element-wise multiplication on the first feature of each point in the second point cloud data and the fused feature of the second point cloud data to obtain a second feature of each point in the second point cloud data, and
determining the global feature of the second point cloud data based on the second feature of each point in the second point cloud data.

6. The method of claim 5, wherein the weight of the second encoder further comprises a fourth sub weight configured to increase the dimension of the extracted feature from the second dimension to a third dimension; and determining the global feature of the second point cloud data based on the second feature of each point in the second point cloud data comprises:
performing at least one of linear transformation or nonlinear transformation on the second feature of each point in the second point cloud data based on the fourth sub weight of the second encoder to obtain a third feature of each point in the second point cloud data, and
extracting, in each feature dimension, a maximum value of the third feature of each point in the second point cloud data to obtain the global feature of the second point cloud data.

7. The method of claim 1, wherein regulating the weight of the first encoder based on the first difference between the first probability distribution and the second probability distribution to obtain the target weight of the first encoder comprises:
determining a second difference between the second probability distribution and a specified probability distribution; and
regulating the weight of the first encoder based on the first difference and the second difference to obtain the target weight of the first encoder.

8. The method of claim 7, wherein regulating the weight of the first encoder based on the first difference and the second difference to obtain the target weight of the first encoder comprises:
decoding the first probability distribution based on a first decoder to obtain third point cloud data after completing the first point cloud data;
decoding the second probability distribution based on a second decoder to obtain fourth point cloud data after reconstructing the second point cloud data; and
regulating the weight of the first encoder and the weight of the first decoder based on the first difference, the second difference, the third point cloud data and the fourth point cloud data to obtain the target weight of the first encoder and a target weight of the first decoder.

9. The method of claim 8, wherein regulating the weight of the first encoder and the weight of the first decoder based on the first difference, the second difference, the third point cloud data and the fourth point cloud data to obtain the target weight of the first encoder and the target weight of the first decoder comprises:
determining a third difference between the third point cloud data and the second point cloud data;
determining a fourth difference between the fourth point cloud data and the second point cloud data; and
regulating the weight of the first encoder and the weight of the first decoder based on the first difference, the second difference, the third difference and the fourth difference to obtain the target weight of the first encoder and the target weight of the first decoder.

10. The method of claim 8, wherein decoding the first probability distribution based on the first decoder to obtain the third point cloud data after completing the first point cloud data comprises:
sampling the first probability distribution to obtain first sample data,
merging the first probability distribution and the first sample data to obtain a first merged probability distribution, and
decoding the first merged probability distribution based on the first decoder to obtain the third point cloud data after completing the first point cloud data; and
decoding the second probability distribution based on the second decoder to obtain the fourth point cloud data after reconstructing the second point cloud data comprises:
sampling the second probability distribution to obtain second sample data,
merging the first probability distribution and the second sample data to obtain a second merged probability distribution, and
decoding the second merged probability distribution based on the second decoder to obtain the fourth point cloud data after reconstructing the second point cloud data.

11. An electronic device, comprising a memory and a processor, wherein
the memory stores a computer program capable of running in the processor; and
when the processor executes the computer program, the processor is configured to:
acquire first point cloud data and second point cloud data of an object, completeness of the second point cloud data being higher than completeness of the first point cloud data;
determine a first probability distribution of a global feature of the first point cloud data based on a first encoder;
determine a second probability distribution of a global feature of the second point cloud data based on a second encoder, the first encoder and the second encoder sharing a weight;
regulate a weight of the first encoder based on a first difference between the first probability distribution and the second probability distribution to obtain a target weight of the first encoder; and
generate a point cloud encoder according to the first encoder and the target weight.

12. The electronic device of claim 11, wherein the processor is further configured to perform feature extraction on the first point cloud data based on the first encoder to obtain the global feature of the first point cloud data and determine the first probability distribution based on the global feature of the first point cloud data; and
the processor is further configured to perform feature extraction on the second point cloud data based on the second encoder to obtain the global feature of the second point cloud data and determine the second probability distribution based on the global feature of the second point cloud data.

13. The electronic device of claim 12, wherein the weight of the first encoder includes a first sub weight configured to increase a dimension of an extracted feature from a first dimension to a second dimension, and the processor is further configured to:
perform at least one of linear transformation or nonlinear transformation on an initial feature of each point in the first point cloud data based on the first sub weight of the first encoder to obtain a first feature of each point in the first point cloud data;
extract, in each feature dimension, a maximum value of the first feature of each point in the first point cloud data to obtain a fused feature of the first point cloud data;
concatenate the first feature of each point in the first point cloud data and the fused feature of the first point cloud data to obtain a second feature of each point in the first point cloud data; and
determine the global feature of the first point cloud data based on the second feature of each point in the first point cloud data.

14. The electronic device of claim 13, wherein the weight of the first encoder further includes a second sub weight configured to increase the dimension of the extracted feature from the second dimension to a third dimension, and the processor is further configured to:
perform at least one of linear transformation or nonlinear transformation on the second feature of each point in the first point cloud data based on the second sub weight of the first encoder to obtain a third feature of each point in the first point cloud data; and
extract, in each feature dimension, a maximum value of the third feature of each point in the first point cloud data to obtain the global feature of the first point cloud data.

15. The electronic device of claim 12, wherein a weight of the second encoder includes a third sub weight configured to increase a dimension of an extracted feature from a first dimension to a second dimension, and the processor is further configured to:
perform at least one of linear transformation or nonlinear transformation on an initial feature of each point in the second point cloud data based on the third sub weight of the second encoder to obtain a first feature of each point in the second point cloud data;
extract, in each feature dimension, a maximum value of the first feature of each point in the second point cloud data to obtain a fused feature of the second point cloud data;
perform element-wise multiplication on the first feature of each point in the second point cloud data and the fused feature of the second point cloud data to obtain a second feature of each point in the second point cloud data; and
determine the global feature of the second point cloud data based on the second feature of each point in the second point cloud data.

16. The electronic device of claim 15, wherein the weight of the second encoder further comprises a fourth sub weight configured to increase the dimension of the extracted feature from the second dimension to a third dimension; and the processor is specifically configured to:
perform at least one of linear transformation or nonlinear transformation on the second feature of each point in the second point cloud data based on the fourth sub weight of the second encoder to obtain a third feature of each point in the second point cloud data, and
extract, in each feature dimension, a maximum value of the third feature of each point in the second point cloud data to obtain the global feature of the second point cloud data.

17. The electronic device of claim 11, wherein the processor is further configured to:
determine a second difference between the second probability distribution and a specified probability distribution; and
regulate the weight of the first encoder based on the first difference and the second difference to obtain the target weight of the first encoder.

18. The electronic device of claim 17, wherein the processor is specifically configured to:
decode the first probability distribution based on a first decoder to obtain third point cloud data after completing the first point cloud data;
decode the second probability distribution based on a second decoder to obtain fourth point cloud data after reconstructing the second point cloud data; and
regulate the weight of the first encoder and the weight of the first decoder based on the first difference, the second difference, the third point cloud data and the fourth point cloud data to obtain the target weight of the first encoder and a target weight of the first decoder.

19. The electronic device of claim 18, wherein the processor is specifically configured to:
determine a third difference between the third point cloud data and the second point cloud data;
determine a fourth difference between the fourth point cloud data and the second point cloud data; and
regulate the weight of the first encoder and the weight of the first decoder based on the first difference, the second difference, the third difference and the fourth difference to obtain the target weight of the first encoder and the target weight of the first decoder.

20. A computer storage medium, storing one or more programs, wherein the one or more programs are executed by one or more processors to perform:
acquiring first point cloud data and second point cloud data of an object, completeness of the second point cloud data being higher than completeness of the first point cloud data;
determining a first probability distribution of a global feature of the first point cloud data based on a first encoder;
determining a second probability distribution of a global feature of the second point cloud data based on a second encoder, the first encoder and the second encoder sharing a weight;
regulating a weight of the first encoder based on a first difference between the first probability distribution and the second probability distribution to obtain a target weight of the first encoder; and generating a point cloud encoder according to the first encoder and the target weight.
